(19) United States
(12) Patent Application Publication
(10) Pub. No.: US 2015/0209985 A1
(43) Pub. Date: Jul. 30, 2015

(54) METHOD FOR MOLDING HOLLOW POLYURETHANE ARTICLE

(71) Applicant: MENQ-FONG SHIEH, Tainan County (TW)

(72) Inventor: MENQ-FONG SHIEH, Tainan County (TW)

(21) Appl. No.: 14/164,347

(22) Filed: Jan. 27, 2014

(51) Int. Cl. B29C 44/16; B29D 22/00

(52) U.S. Cl. CPC B29C 44/16; B29D 22/00; B29K 2027/06

(57) ABSTRACT

A fabricating method of a hollow polyurethane (PU) article of the disclosure includes following steps. A molding sheet is provided and a release film is provided to combining upon the molding sheet. The molding sheet with the release film is molded to be a sub mould. An inner surface of the sub mould is sprayed with paint, and the paint is mixed with glitter powder. The painted sub mould is dried. The dried sub mould is positioned on a molding mould. The molding mould is filled with PU composite. The PU composite is foamed to form a sub PU article. The sub PU article is demoulded. At least two sub PU articles are joined to form the hollow PU article.

### BACKGROUND

1. Technical Field

The present disclosure generally relates to methods of molding polyurethane articles, and especially to a fabricating method of a hollow polyurethane article.

2. Description of Related Art

With development of technology and improvement of people's life, decorations for festival and holidays are more and more popular with people. Polyurethane (PU) material is used widely in decorating area, because the PU material can be molded different kinds of three-dimensional articles, and can be carried out mass production easily. In order to achieve decoration effect, exterior surface of the PU article is generally coated with paint. And furthermore, in order to get attention of consumers, the paint is usually mixed with glitter power to get a glitter effect of the decoration.

Traditionally, after the PU composite is foamed to be a PU article, the paint mixed with the glitter power is sprayed on the exterior surface of the PU article. However, it is difficult to spray the paint on the exterior surface of the PU article, thus, the exterior surface of the PU article must be cleaned with chemicals, or solvent-type paint is used to directly spray on the exterior surface of the PU article. With the manufacturing processes described above, the glitter power is attached on the exterior surface of the PU article in the form of particles. As a result, the glitter power easily drops from the exterior surface of the PU article, due to mis-operation, which causes environmental pollution.

Therefore, a need exists in the industry to overcome the described problems.

### SUMMARY

The purpose of the disclosure is to solve the problem that glitter power easily drops from an exterior surface of a hollow polyurethane (PU) article to causes environmental pollution.

In order to solve the problem, the disclosure offers technical proposals as follow.

A fabricating method of a hollow polyurethane (PU) article includes providing a molding sheet and combining a release film upon the molding sheet; molding the molding sheet with the release film to be a sub mould; spraying paint on an inner surface of the sub mould, and wherein the paint is mixed with glitter powder; drying the painted sub mould; positioning the dried sub mould on a molding mould; filling the molding mould with PU composite; foaming the PU composite to form a sub PU article; demoulding the sub PU article; and joining at least two sub PU articles to form the hollow PU article.

Preferably, before the step of joining at least two sub PU articles to form the hollow PU article, the fabricating method further includes a step of polishing a joining surface of the sub PU article.

Preferably, the step of spraying paint on the inner surface of the sub mould includes: spraying a first paint on the inner surface of the sub mould, and wherein the first paint is water-based and transpicuous, and is mixed with the glitter powder; drying the sub mould with the first paint; and spraying a second paint on the inner surface of the sub mould, and wherein the second paint is colored paint.

Preferably, the molding sheet is made of polyvinyl chloride polymer (PVC).

Preferably, the release film is made of polyethylene (PE).

Preferably, the molding sheet is formed to be the sub mould by a hot extrusion process.

Preferably, the molding sheet is formed to be the sub mould by a vacuum forming process.

It follows that, during the foaming process of the sub PU article, the sub PU article is molded according to an original shape of the sub PU article, due to the moldability of the sub mould and the separability of the release film. The paint mixed with the glitter power on the release film is transferred to coat on the exterior surface of the sub PU article, which not only prevents the power glitter dropping from the exterior surface of the sub PU article, but also improves the production environment and reduces the environment pollution.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a sectional view of a hollow polyurethane (PU) article of an exemplary embodiment according to the present disclosure.

FIG. 2 is a flow chart of an exemplary embodiment of a fabricating method of the hollow PU article of FIG. 1.

FIG. 3 is a schematic view of a molding sheet combined with a release film.

FIG. 4 is a schematic view of molding the molding sheet with the release film to be a sub mould.

FIG. 5 is a schematic view of spraying paint on an interior surface of the sub mould.

FIG. 6 is a schematic view of foaming PU composite to form a sub PU article.

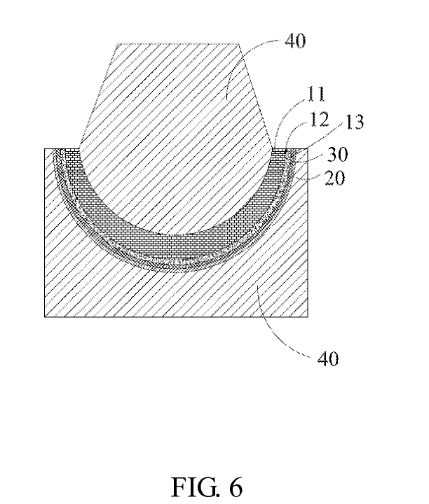

FIG. 7 is a schematic view of the demoulded sub PU article.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

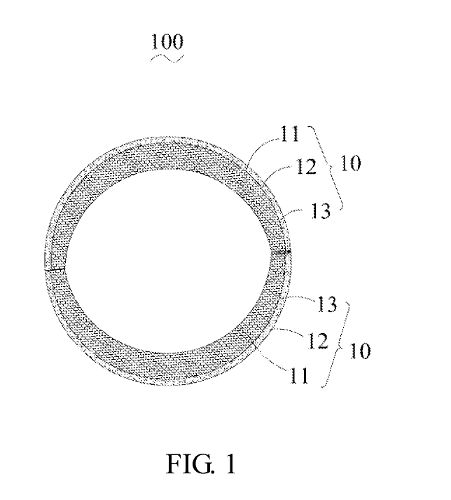

With reference to FIG. 1, a hollow polyurethane (PU) article 100 according to an exemplary embodiment of the disclosure includes a pair of sub PU article 10. The pair of sub PU article 10 are joined together to form the hollow PU article 100. The hollow PU article 100 includes a paint layer 12 covering an exterior surface of the hollow PU article 100. Paint of the paint layer 12 is mixed with glitter power 13, which results a glitter effect of an appearance of the hollow PU article 100 to decorate the environment of a festival holiday.

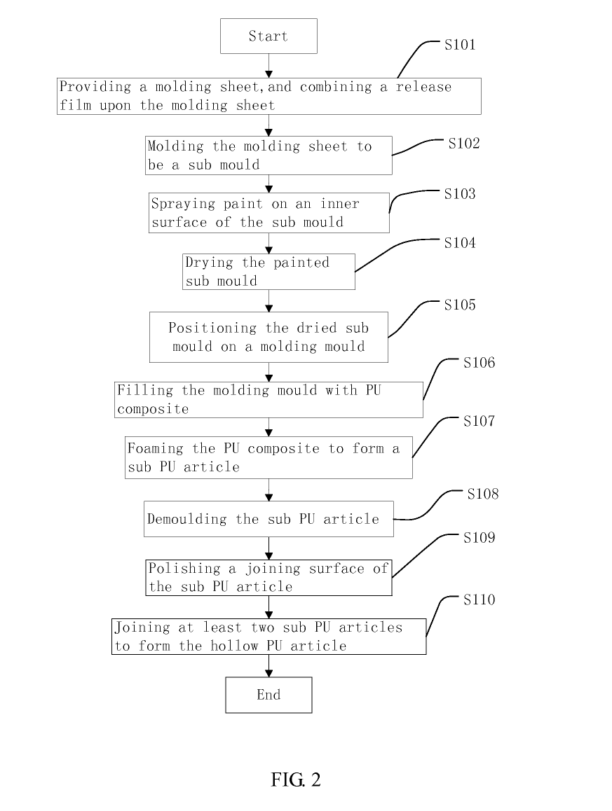

FIG. 2 is a flow chart of an exemplary embodiment of a fabricating method of the hollow PU article 100 of FIG. 1. The fabricating method comprises following steps.

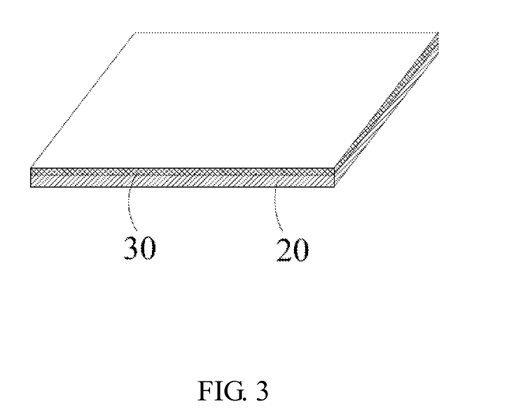

In step S101, a molding sheet 20 is provided, and a release film 30 is combined upon the molding sheet 20, as shown in FIG. 3. In the embodiment, the molding sheet 20 is made of PVC (Polyvinyl Chloride Polymer). The sub PU article 10 can be molded according to an original shape of the sub PU article 10, because of good formability of PVC material.

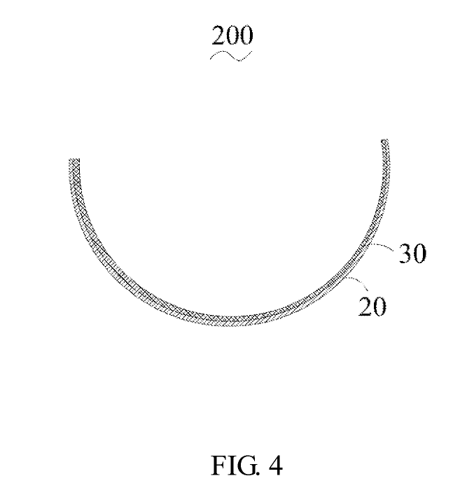

In step S102, the molding sheet 20 with the release film 30 is molded to be a sub mould 200, as shown in FIG. 4. The shape of the sub mould 200 is same as that of the sub PU article 10. In the embodiment, the release film 30 is made of PE (polyethylene). The sub PU article 10 is detached from the sub mould 200 easily because of good separability of the release film 30 which is made of PE.

In the embodiment, the molding sheet 20 with the release film 30 is molded to be the sub mould 200 by a hot extrusion process. Alternatively, the molding sheet 20 with the release film 30 is molded to be the sub mould 200 by a vacuum forming process.

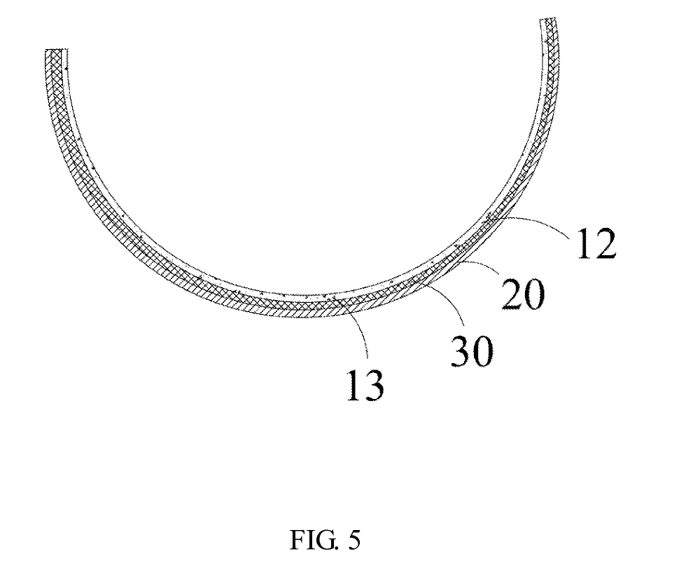

In step S103, an interior surface of the sub mould 200 is sprayed with the paint to form a paint layer 12. The paint is mixed with the glitter power 13. In the embodiment, the glitter power 13 is in a shape of particles, as shown in FIG. 5.

In step S104, the painted sub mould 200 is dried.

In step S105, the dried sub mould 200 is positioned on a molding mould 40 with an exterior surface of the sub mould 200 contacting an interior surface of the molding mould 40.

In step S106, PU composite 11 is filled into the molding mould 40.

In step S107, the PU composite 11 is foamed to form the sub PU article 10.

During the foaming process of the PU composite 11, the paint on an surface of the release film 30 is transferred to print on the exterior surface of the sub PU article 10. In addition, the PU composite 11 generates a strong viscous force under a high temperature during the foaming process, and the particles of the glitter power 13 are attached to the PU composite 11 firmly under the strong viscous force of the PU composite 11. As a result, it is difficult for the glitter power 13 to drop from the exterior surface of the sub PU article 10, which improves production environment and reduce environment pollution.

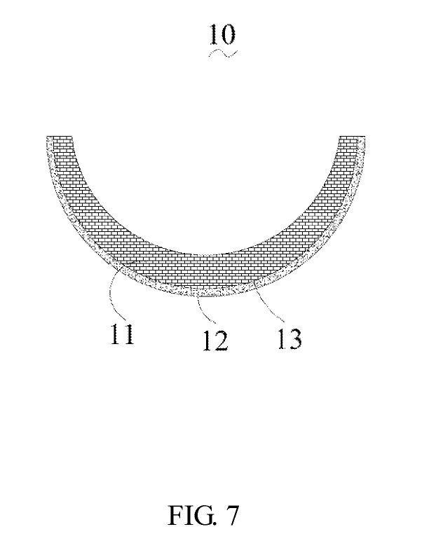

In step S108, the sub PU article 10 is demoulded from the molding mould 40 and the sub mould 200, shown as in FIG. 7. In detail, the sub PU article 10 and the sub mould 200 are detached from the molding mould 40 together. Subsequently, the sub PU article 10 is detached from the sub mould 200. The sub PU article 10 is detached from the sub mould 200 easily because of the release film 30 located between the sub mould 200 and the sub PU article 10.

In step S110, at least two sub PU article 10 are joined together to form the hollow PU article 100.

Alternatively, before the step S110 of joining the two sub PU article 10, the fabricating method of the hollow PU article 100 further includes a step S109 of polishing a joining surface of the sub PU article 10 smoothly. As a result, a gap between two joining surfaces of the sub PU articles 10 is reduced.

In the embodiment, the step S103 of spraying the paint on the interior surface of the sub mould 200 includes following steps:

In step one, the interior surface of the sub mould 200 is sprayed with a first paint. The first paint is water-based and transpicuous, and is mixed with the glitter powder 13.

In step two, the sub mould 200 with the first paint is dried.

In step three, the inner surface of the sub mould 200 is sprayed with a second paint. The second paint is colored paint. In the embodiment, the spraying step on the interior surface of the sub mould 200 is divided two spraying steps with different paints, which results low cost due to the price of the water-based and transpicuous paint is cheaper than that of the colored paint.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A method for molding a hollow polyurethane (PU) article, comprising:
providing a molding sheet, and combining a release film upon the molding sheet;
molding the molding sheet with the release film to be a sub mould;
spraying paint on an inner surface of the sub mould, and wherein the paint is mixed with glitter powder;
drying the painted sub mould;
positioning the dried sub mould on a molding mould;
filling the molding mould with PU composite;
foaming the PU composite to form a sub PU article;
demoulding the sub PU article; and
joining at least two sub PU articles to form the hollow PU article.

2. The method of claim 1, before the step of joining at least two sub PU articles to form the hollow PU article, further comprising a step of polishing a joining surface of the sub PU article.

3. The method of claim 1, wherein the step of spraying paint on an inner surface of the sub mould comprises steps of:
spraying a first paint on the inner surface of the sub mould, and wherein a first paint is water-based and transpicuous and is mixed with the glitter powder;
drying the sub mould with the first paint; and
spraying a second paint on the inner surface of the sub mould, and wherein the second paint is colored paint.

4. The method of claim 1, wherein the molding sheet is made of polyvinyl chloride polymer (PVC).

5. The method of claim 1, wherein the release film is made of polyethylene (PE).

6. The method of claim 1, wherein the molding sheet is formed to be the sub mould by a hot extrusion process.

7. The method of claim 1, wherein the molding sheet is formed to be the sub mould by a vacuum forming process.
